(19) United States
(12) Patent Application Publication
(10) Pub. No.: US 2023/0247950 A1
(43) Pub. Date: Aug. 10, 2023

(54) SPRINKLER, IRRIGATION SYSTEM AND ASSOCIATED METHODS

(71) Applicant: H2O INNOVATION INC., Québec (CA)

(72) Inventor: Rock GAULIN, Sherbrooke (CA)

(21) Appl. No.: 18/163,964

(22) Filed: Feb. 3, 2023

Related U.S. Application Data
(60) Provisional application No. 63/307,287, filed on Feb. 7, 2022.

(51) Int. Cl. A01G 25/16; A01G 25/02

(52) U.S. Cl. CPC A01G 25/16; A01G 25/02; H04L 67/12

(57) ABSTRACT

A sprinkler has an internal cavity where fluid is configured to flow through the internal cavity along a flow path extending from an inlet to an outlet. A sprinkler head is in fluid communication with the internal cavity of the body and is rotatable about a sprinkler head axis. A sprinkler power assembly generates electrical power for diagnostics of the sprinkler, such as a motion sensor oriented toward the sprinkler head. The motion sensor is configured to emit a motionless signal upon the sprinkler head ceasing to rotate about the sprinkler head axis.

### TECHNICAL FIELD

The application relates generally to fluid conveyance devices and, more particularly, to sprinklers.

### BACKGROUND

In temperate or cold climates, agricultural crops may be exposed to frost damage during colder periods of the year. One of the defences against frost damage involves irrigating or wetting the crops and the soil in which they grow prior to anticipated frosting. Such irrigation or wetting may be performed with water-spreading devices, such as sprinklers. However, these devices may malfunction or become inoperative due to the accumulation of ice on the devices, which prevents them from spreading the water. When these devices malfunction, they become less effective at preventing frost damage.

### SUMMARY

There is disclosed a sprinkler, comprising: a body having an inlet and an outlet, the body having an internal cavity in fluid communication with the inlet and with the outlet, fluid configured to flow through the internal cavity along a flow path extending from the inlet to the outlet; a sprinkler head in fluid communication with the internal cavity of the body and rotatable about a sprinkler head axis; and a sprinkler power assembly comprising: a rotor with a rotor shaft and rotor blades rotatable about a rotor axis, the rotor blades in fluid communication with the inner cavity and positioned along the flow path, the rotor blades and the rotor shaft configured to be rotated by the fluid flowing along the flow path; and an electrical generator coupled to the rotor shaft.

There is disclosed a sprinkler, comprising: a body having an inlet and an outlet, the body having an internal cavity in fluid communication with the inlet and with the outlet, fluid configured to flow through the internal cavity along a flow path extending from the inlet to the outlet; a sprinkler head in fluid communication with the internal cavity of the body and rotatable about a sprinkler head axis; and a communication system comprising: a power source positioned on the body; a motion sensor positioned on the body, the motion sensor oriented toward the sprinkler head and configured to emit a motionless signal upon the sprinkler head ceasing to rotate about the sprinkler head axis; and a controller positioned on the body and powered by the power source, the controller in communication with the motion sensor to transmit the motionless signal.

There is disclosed a self-diagnostic kit for a sprinkler, the self-diagnostic kit comprising: a power source mountable to the sprinkler; a motion sensor mountable to the sprinkler to be oriented toward a rotatable sprinkler head, the motion sensor configured to emit a motionless signal upon the rotatable sprinkler head ceasing to rotate; and a controller configured to be powered by the power source and to transmit the motionless signal.

There is disclosed an agricultural irrigation system, comprising: piping for conveying a fluid to an agriculture field; and sprinklers, each sprinkler of at least some of the sprinklers comprising: a body having an inlet in fluid communication with the piping and an outlet in fluid communication with the piping, the body having an internal cavity in fluid communication with the inlet and with the outlet, the fluid configured to flow through the internal cavity along a flow path extending from the inlet to the outlet; a sprinkler head in fluid communication with the internal cavity of the body and rotatable about a sprinkler head axis; and a communication system comprising: a power source positioned on the body; a motion sensor positioned on the body, the motion sensor oriented toward the sprinkler head and configured to emit a motionless signal upon the sprinkler head ceasing to rotate about the sprinkler head axis; and a controller positioned on the body and powered by the power source, the controller in communication with the motion sensor to transmit the motionless signal.

There is disclosed a method of detecting a sprinkler being inoperative, the method comprising: monitoring a rotation of a sprinkler head of the sprinkler with a motion sensor; and emitting a motionless signal when the motion sensor detects that the sprinkler head has stopped rotating.

There is disclosed a method of detecting a sprinkler being inoperative, the method comprising: monitoring a rotation of a sprinkler head of the sprinkler with a motion sensor; and emitting a motionless signal with the motion sensor when ice obstructs or blocks the sprinkler head and causes the sprinkler head to stop rotating.

There is disclosed a method of protecting an agriculture field from frost, the method comprising: irrigating the agriculture field with a fluid conveyed through sprinklers during or in advance of frost conditions; monitoring a rotation of a sprinkler head of at least one of the sprinklers with a motion sensor; emitting a motionless signal when the motion sensor detects that the sprinkler head of the at least one of the sprinklers has stopped rotating; and inspecting, when the motionless signal is received, the sprinkler head for malfunction due to ice accumulation on the sprinkler head.

### DESCRIPTION OF THE DRAWINGS

Reference is now made to the accompanying figures in which:

FIG. 1 is a schematic view of an agricultural field having an irrigation system with sprinklers;

FIG. 2A is a perspective view of one of the sprinklers of FIG. 1;

FIG. 2B is another perspective view of the sprinkler of FIG. 2A;

FIG. 2C is another perspective view of the sprinkler of FIG. 2A;

FIG. 2D is another perspective view of part of the sprinkler of FIG. 2A;

FIG. 3 is a block diagram of an example computing device;

FIG. 4 is a block diagram of examples of the sprinkler of FIG. 2A;

FIG. 5 is another perspective view of part of the sprinkler of FIG. 2A; and

FIGS. 6 to 8 are flow charts of example methods associated with the sprinkler.

### DETAILED DESCRIPTION

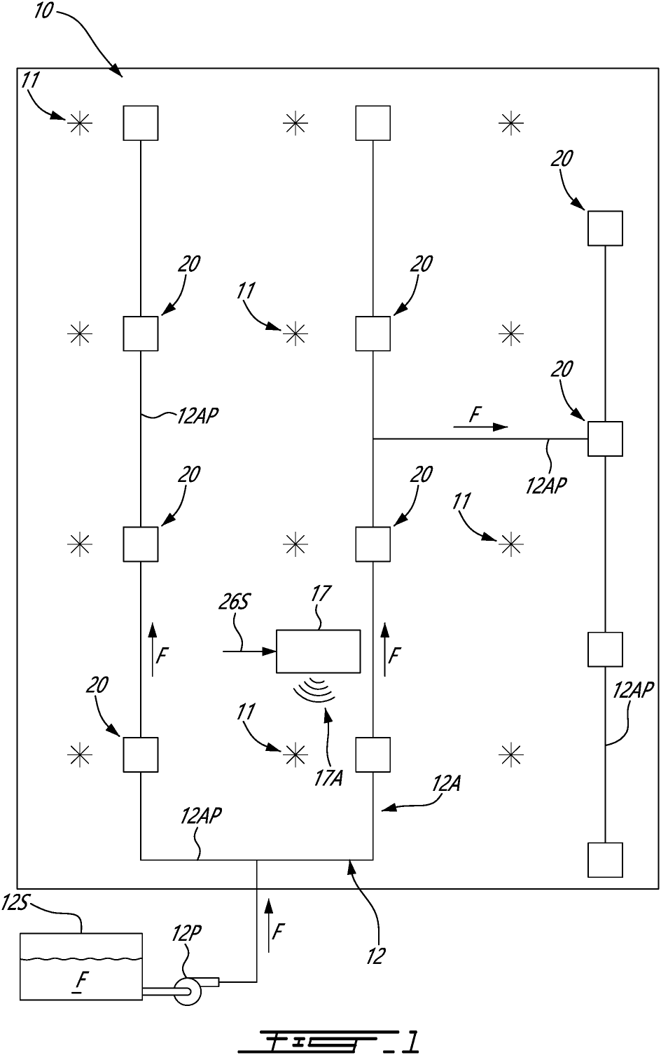

FIG. 1 illustrates an agriculture field 10 used for growing crops 11. The agricultural field 10 can be of any size or shape, and the crops 11 grown on the agricultural field 10 (sometimes referred to herein simply as “the field 10”) can be of any type. For example, in an embodiment, the crops 11 are those whose growth may be encouraged by, or which may be protected by (as explained below), an agricultural irrigation system 12. The agricultural irrigation system 12 helps the crops 11 to grow by supplying a fluid F, such as water or a water-based solution, to the crops 11. In order to convey the fluid F to the crops 11, the agricultural irrigation system 12 (sometimes referred to herein simply as “the irrigation system 12”) may include any suitable components in any arrangement. For example, and referring to FIG. 1, the irrigation system 12 has one or more pumps 12P which provide or supply the fluid F from a fluid source 12S. The pump(s) 12P convey the fluid F under pressure from the fluid source 12S through a network of piping 12A of the irrigation system 12. The piping 12A includes one or more pipes 12AP or other fluid conduits which are interconnected and in fluid communication with each other. The pipe(s) 12AP extend along and/or through the field 10 to disperse the fluid F to different locations of the field 10 which have crops 11. In an embodiment, the irrigation system 12 is a permanent fixture of the field 10 and is used throughout the growing season to irrigate the crops 11. In another embodiment, the irrigation system 12 is temporary or semi-permanent, in that it is used during part of the growing season. In one possible configuration of the temporary or semi-permanent irrigation system 12, the irrigation system 12 is mounted to or part of a mobile platform which may be deployed when needed, such as in anticipation of potential frost damage to the crops 11, as explained in greater detail below. Other configurations for the irrigation system 12 are possible and within the scope of the present disclosure.

Referring to FIG. 1, the irrigation system 12 includes multiple fluid-distribution devices to disperse the fluid F to the crops 11 at different locations of the field 10. These fluid-distribution devices are referred to herein as sprinklers 20. The sprinklers 20 are devices that are used for spraying the fluid F over or among the crops 11. The irrigation system 12 may include other types of fluid-distribution devices, in addition to the sprinklers 20. Referring to FIG. 1, the sprinklers 20 of the irrigation system 12 are distributed throughout the field 10 and positioned at different locations of the field 10 in order to disperse the fluid F to the different locations of the field 10. In the embodiment where the irrigation system 12 is mobile, the sprinklers 20 may be mounted to different locations of the mobile platform or vehicle which displaces the irrigation system 12. Referring to FIG. 1, the sprinklers 20 are mounted to the pipe(s) 12AP of the piping 12A, such that the sprinklers 20 receive the fluid F from the pipe(s) 12AP. In the configuration of the sprinklers 20 shown in FIG. 1, the sprinklers 20 are arranged in series, such that the fluid F flowing out of one of the sprinklers 20 is fed, via the pipe(s) 12AP, to another downstream sprinkler 20. Other configurations for the sprinklers 20 are possible. For example, in an alternate embodiment, the pipe(s) 12AP are arranged to feed multiple sprinklers 20 at the same time, such that one or more of the sprinklers 20 are arranged in parallel.

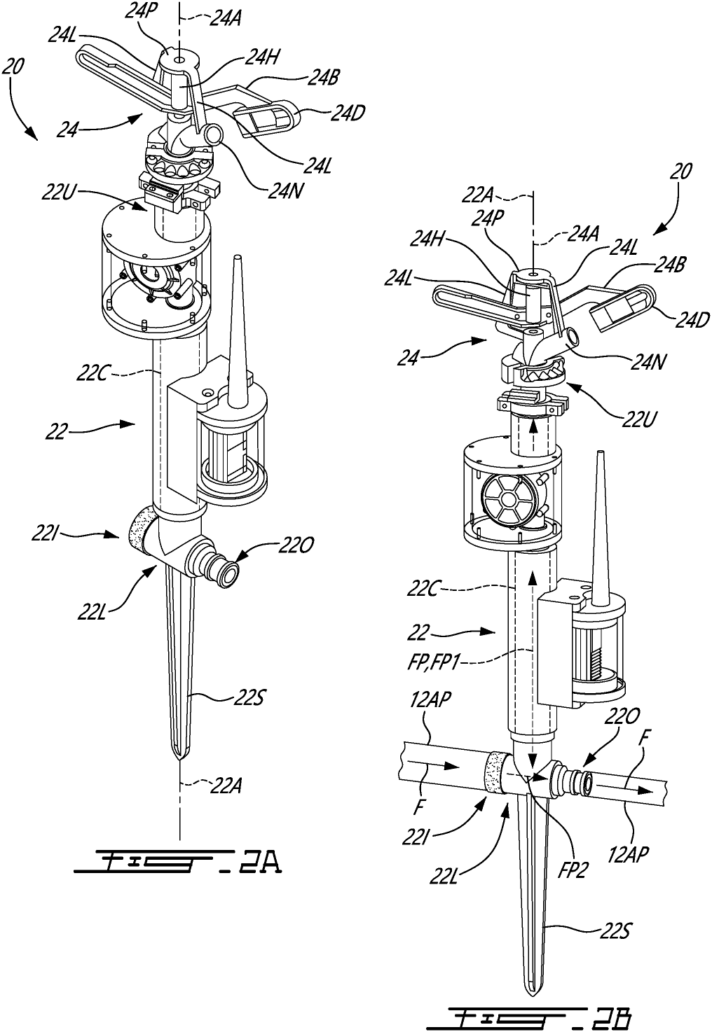

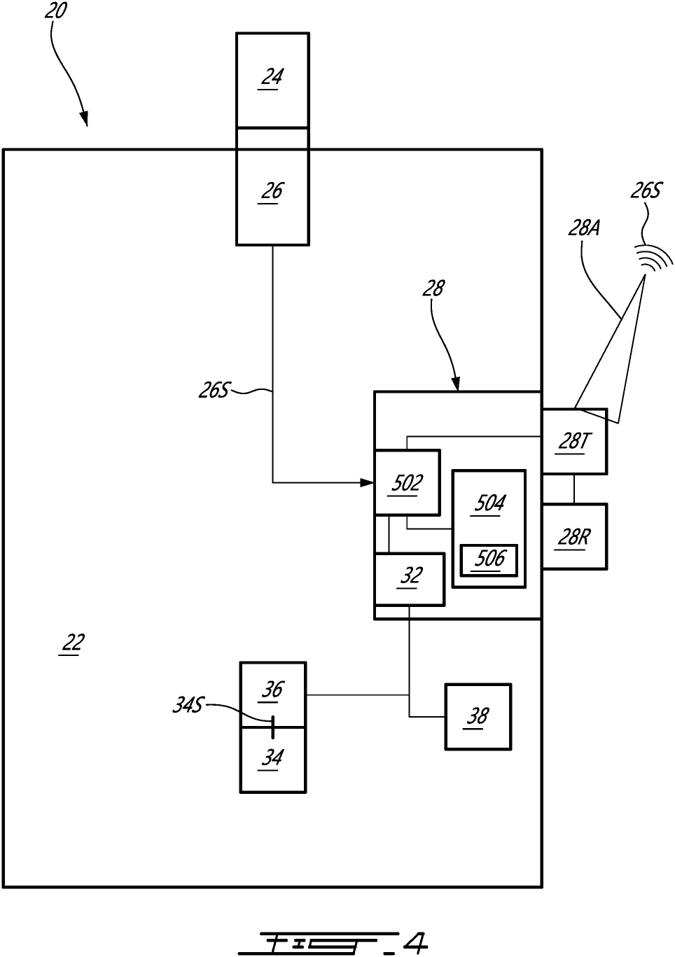

FIGS. 2A and 2B show one of the sprinklers 20 of the irrigation system 12. The description below of the sprinkler 20 and its features shown in FIGS. 2A to 2D and 5 applies to two, more than two, or all of the sprinklers 20 of the irrigation system 12.

Referring to FIGS. 2A and 2B, the sprinkler 20 has a body 22. The body 22 forms the corpus of the sprinkler 20 and provides support thereto. The body 22 has an inlet 22l which receives the fluid F from the pipe(s) 12AP connected to the inlet 22l. The body 22 has an outlet 22O which receives the fluid F from the inlet 22l and conveys the fluid F to downstream pipe(s) 12AP connected to the outlet 22O. The fluid F is able to flow, under pressure, from the inlet 22I to the outlet 22O via an internal cavity 22C of the body 22 which fluidly connects the inlet 22l and the outlet 22O. The body 22 is thus at least partially hollow, so that the fluid F is able to flow into the body 22 via the inlet 22l, through the cavity 22C and out the body 22 via the outlet 22O. The fluid F is configured to flow through the body 22 along a fluid flow path FP that starts at the inlet 22l, extends through the internal cavity 22C, and ends at the outlet 22O.

Different configurations of the body 22 are possible. For example, and referring to FIGS. 2A and 2B, the body 22 is an elongated, linear tube that defines a longitudinal center axis 22A. The inlet 22l and the outlet 22O are at a first end 22L of the body 22, where the first end 22L of the body 22 is closest to the field 10 when the sprinkler 20 has a vertical orientation. The inlet and the outlet 22l,22O are spaced apart from each other in a radial or lateral direction relative to the center axis 22A. The inlet and the outlet 22l,22O have the same axial position defined along the center axis 22A. The inlet 22l and the outlet 22O have threaded flanges or other fastening devices for securing the pipe(s) 12AP to the body 22. The cavity 22C extends along the center axis 22A and is co-axial with the center axis 22A. The body 22 includes a stake 22S extending in a direction parallel to the center axis 22A and positioned beneath the inlet and the outlet 22l,22O. The sprinkler 20 of FIGS. 2A and 2B is configured to be secured to the ground of the field 10 by driving the stake 22S into the ground, such that sprinkler 20 and its body 22 has an upright or vertical orientation when being used. The sprinkler 20 of FIGS. 2A and 2B is thus intended to have a fixed position prior to, and while, being used, with respect to the field 10. Other configurations for the body 22 are possible. For example, the body 22 may have other shapes, such as annular or box-like. The body 22 may have another type of fixation, such as a clamp or other mount, to attach the body 22 and thus the sprinkler 20 to a mobile platform or vehicle, such that the sprinkler 20 is a “lateral” moving sprinkler 20.

Referring to FIGS. 2A and 2B, the sprinkler 20 has a sprinkler head 24. The sprinkler head 24 is the portion of the sprinkler 20 which disperses the fluid F from the sprinkler 20 and over the field 10. The sprinkler head 24 is in fluid communication with the cavity 22C of the body 22, so that the fluid F can be conveyed from the inlet 22l to the sprinkler head 24. The sprinkler head 24 is downstream of the inlet 22l of the body 22. In the configuration of the sprinkler 20 of FIGS. 2A and 2B, the fluid flow path FP has a first portion FP1 that extends from the inlet 22l and upwardly to the sprinkler head 24, and a second portion FP2 that extends from the inlet 22l to the outlet 22O. Thus, in the configuration of the sprinkler 20 of FIGS. 2A and 2B, the fluid F is directed from the inlet 22l to both the sprinkler head 24 and to the outlet 22O, such that some of the fluid F entering the sprinkler 20 is dispersed over the field 10 via the sprinkler head 24, and some of the fluid F is conveyed out of the sprinkler 20 via the outlet 22O. In the configuration of the sprinkler 20 of FIGS. 2A and 2B, the sprinkler head 24 is mounted to the body 22 at the second end 22U of the body 22. The second end 22U is axially spaced apart from the first end 22L, and is spaced further from the ground than the first end 22L when the sprinkler 20 is staked to the ground.

Referring to FIGS. 2A and 2B, the sprinkler head 24 is rotatable about a sprinkler head axis 24A. The rotation of the components of the sprinkler head 24 about the sprinkler head axis 24A helps to distribute the fluid F from the sprinkler 20, and helps the sprinkler 20 to disperse the fluid F in a spray form. In the configuration of the sprinkler 20 of FIGS. 2A and 2B, the sprinkler head axis 24A is upright or substantially vertical when the sprinkler 20 is staked to the ground. The sprinkler head axis 24A is parallel, and may be collinear with, the center axis 22A of the body 22. The sprinkler head 24 may rotate less than a full revolution about the sprinkler head axis 24A, so that it sprays less than a 360 degree extent of the field 10. Alternatively, the sprinkler head 24 may rotate a full revolution about the sprinkler head axis 24A so that it sprays an entire 360 degree extent of the field 10. The sprinkler head axis 24A may have other orientations, such as horizontal or at an angle between 0 and 180 degrees, depending on the configuration of the sprinkler 20. For example, in an embodiment where the sprinkler head 24 extends horizontally, the sprinkler head axis 24A may have a horizontal orientation.

The sprinkler head 24 may have any component, shape or configuration to achieve the functionality ascribed to it herein. For example, and referring to FIGS. 2A and 2B, the sprinkler head 24 has a nozzle 24N through which the fluid F is ejected under pressure, and which is rotatable about the sprinkler head axis 24A. The fluid F ejected from the nozzle 24N impacts a disperser 24D of the sprinkler head 24. The disperser 24D functions to disperse the fluid F as a spray over the field 10. The disperser 24D is mounted to one extremity of a drive arm 24B of the sprinkler head 24. The drive arm 24B extends from a hub 24H, and both the drive arm 24B and the hub 24H are rotatable about the sprinkler head axis 24A. The hub 24H is mounted at an outer end thereof to a rotation plate 24P, which is also rotatable about the sprinkler head axis 24A. Linking arms 24L which are rotatable about the sprinkler head axis 24A extend downwardly from the rotation plate 24P and connect to the nozzle 24N. The drive arm 24B extends through the linking arms 24L. The sprinkler head 24 of FIGS. 2A and 2B functions as follows. The fluid F ejected under pressure from the nozzle 24N impacts the disperser 24D. This causes the disperser 24D, and the hub 24H and drive arm 24B linked thereto, to rotate about the sprinkler head axis 24A. The rotating drive arm 24B impacts one or both of the linking arms 24L, transferring a rotational motion to the linking arms 24L which causes the rotating plate 24P and the nozzle 24N to also rotate about the sprinkler head axis 24A, such that the nozzle 24N has a new circumferential position relative to the sprinkler head axis 24A.

One, two, more than two, or all of the sprinklers 20 are capable of self-diagnosing and reporting when they are malfunctioning. One, two, more than two, or all of the sprinklers 20 are powered by electricity, and may be capable of generating their own electrical power. These functionalities are described in greater detail below with respect to one such sprinkler 20, and it will be understood that the description below of this one sprinkler 20 applies to two, more than two, or all of the sprinklers 20 of the irrigation system 12.

Referring to FIGS. 2C and 2D, the self-diagnosing functionality of the sprinkler 20 is described in greater detail. The sprinkler 20 has a motion sensor 26. The motion sensor 26 is mounted to, or otherwise positioned on, the body 22. In the configuration of the sprinkler 20 of FIGS. 2C and 2D, the motion sensor 26 is positioned adjacent to the second end 22U of the body 22. The motion sensor 26 functions to monitor and detect the motion, or lack thereof, of the sprinkler head 24 or a component thereof, and to signal when the sprinkler head 24 is not moving as desired. The motion sensor 26 is thus oriented toward the sprinkler head 24, in order to detect the movement of the sprinkler head 24. The sprinkler head 24 may not be moving as desired because it, or a component thereof (e.g. the nozzle 24N, the disperser 24D, the drive arm 24B, etc.), may be prevented from moving as desired as a result of the accumulation of ice on the component. The sprinkler head 24 may not be moving as desired because it, or a component thereof (e.g. the nozzle 24N, the disperser 24D, the drive arm 24B, etc.), may be prevented from moving as desired as a result of a blockage resulting from something inside the sprinkler 20 (such as rock, sand, algae, etc.). The motion sensor 26 therefore is able to detect and signal when ice accumulation or a blockage prevents the sprinkler 20 from functioning as desired.

The motion sensor 26 may have different configurations to achieve this functionality. For example, and referring to FIGS. 2C and 2D, the motion sensor 26 includes a magnet 26M mounted to the sprinkler head 24 to rotate with the sprinkler head 24 about the sprinkler head axis 24A. Referring to FIGS. 2C and 2D, the magnet 26M is a disc 26MD made of a ferromagnetic material. The disc 26MD includes two semi-circular halves attached together around a shaft of the sprinkler head 24 that is coaxial with the sprinkler head axis 24A. The disc 26MD includes multiple holes 26MH that are circumferentially spaced apart on one of the halves of the disc 26MD. The holes 26MH may each include a magnet. Each hole 26MH, and thus each magnet contained therein, occupies a unique circumferential position with respect to the sprinkler head axis 24A..

The motion sensor 26 includes a sensor element 26E which is fixedly mounted to the body 22 of the sprinkler 20. The sensor element 26E does not rotate about the sprinkler head axis 24A. The sensor element 26E is secured to the body 22 by two coupling devices that are fastened together. The sensor element 26E is spaced apart from the magnet 26M along a direction that is parallel to the center axis 22A and to the sprinkler head axis 24A. The sensor element 26E detects the magnetic field of the magnet 26M and changes in the magnetic field caused by the rotation of the magnet 26M, and/or by the rotation of any magnets in the holes 26MH of the disc 26MD, about the sprinkler head axis 24A. In an embodiment, the sensor element 26E is a Hall element, and the motion sensor 26 is a Hall effect sensor. In an alternate embodiment, the magnet 26M is mounted to the stationary body 22 and the sensor element 26E is mounted to the rotating sprinkler head 24. The motion sensor 26 of FIGS. 2C and 2D functions as follows. When the sprinkler head 24 is functioning as desired and rotating about the sprinkler head axis 24A, the magnet 26M of the motion sensor 26 is also rotating about the sprinkler head axis 24A. The sensor element 26E, in the embodiment where it is a Hall element, will experience or record a variation in the Hall voltage across the sensor element 26E that is predictable and recurring. However, when the sprinkler head 24 is not functioning as desired and stops rotating about the sprinkler head axis 24A or decreases the speed of rotation, the magnet 26M of the motion sensor 26 will also stop rotating about the sprinkler head axis 24A, or also decrease its speed of rotation. The sensor element 26E, in the embodiment where it is a Hall element, will thus experience or record no variation, or a smaller variation, in the Hall voltage across the sensor element 26E, which is an indication that the sprinkler head 24 may be blocked by ice accumulation. The holes 26MH in one of the halves of the disc 26MD of the magnet 26M may improve the sensitivity or the precision of the sensor element 26E. More particularly, the extent to which the sprinkler head 24 is blocked may be determined from the circumferential position of any magnets within the holes 26MH and their effect on the variation in the Hall voltage.

When the sensor element 26E determines that the sprinkler head 24 is not moving as desired (e.g. ice build up which will cause stoppage of the sprinkler head 24 is impending) or has stopped moving (e.g. ice build up has already caused stoppage of the sprinkler head 24) for longer than a threshold period of time, the motion sensor 26 will emit a motionless signal 26S. The motionless signal 26S can provide an indication that the sprinkler 20 is not functioning as desired (e.g. the sprinkler head 24 is motionless). Depending on the embodiment, it can be proactive or reactive. In an example of a reactive embodiment, the motionless signal can be emitted when motion is not confirmed by the sensor. In an example of a proactive embodiment, the motionless signal can be in the form of absence of a signal which is usually emitted when the motion is detected by the sensor. The motionless signal 26S may contain information about the sprinkler 20 that has malfunctioned, such as an identifier unique to the sprinkler 20 and/or its location within the field 10. The motionless signal 26S may be transmitted by wire to a controller 28 of the sprinkler 20, which is described in greater detail below. The motion sensor 26 in an embodiment has a default operating mode in which the motionless signal 26S is not emitted until the motion sensor 26 detects that the sprinkler head 24 is not moving as desired.

Although described with respect to FIGS. 2C and 2D as a magnetic motion sensor 26, other configurations of the motion sensor 26 are possible. For example, in an alternate embodiment, the motion sensor 26 is an optical sensor including a light-emitter on one of the body 22 and the sprinkler head 24, and a light-detector on the other of the body 22 and the sprinkler head 24. In another possible configuration, the motion sensor 26 is a hydraulic sensor which monitors the flow of the fluid F through the sprinkler head 24 or upstream thereof at the body 22, and emits the motionless signal 26S when the flow of fluid F deviates from a threshold value for longer than a threshold period of time. In another possible configuration, the motion sensor 26 is a mechanical sensor which is triggered when rotation of the sprinkler head 24 relative to the body 22 stops or slows to below a desired angular speed.

Irrespective of its configuration, the motion sensor 26 emits the motionless signal 26S to the controller 28. Referring to FIGS. 2C and 2D, the controller 28 is positioned on the body 22 of the sprinkler 20 and is powered by an electrical power source 32. The controller 28 is in signal communication with the motion sensor 26 to receive the motionless signal 26S from the motion sensor 26. One possible configuration of this signal communication is achieved with a wire that extends along the body 22 from the motion sensor 26 to the controller 28. The controller 28 operates to transmit the motionless signal 26S, or a signal derived from the motionless signal 26S, away from the sprinkler 20 to alert that the sprinkler 20 is not functioning as desired. Referring to FIGS. 2C and 2D, the controller 28 has a transmitter 28T for transmitting the motionless signal 26S. The transmission from the transmitter 28T is amplified by an antenna 28A. Referring to FIGS. 2C and 2D, the controller 28 and the transmitter 28T are housed within a controller housing 28H which can be attached to the body 22. The controller housing 28H is positioned on the body 22 between the first and second ends 22L,22U. The controller housing 28H is impermeable to prevent the ingress of water or debris into the controller housing 28H, and includes a transparency 28B so that the interior of the controller housing 28H can be viewed.

In an embodiment, and referring to FIG. 1, the irrigation system 12 has a receiver 17 positioned on or near the field 10 to receive the motionless signal 26S from the transmitter 28T of the controller 28. The receiver 17 may be part of a base station of the irrigation system 12 that is located on, or in proximity to, the field 10. The receiver 17 is in communication with the controller 28 of each sprinkler 20 which is capable of self-diagnosing itself, which may be some or all of the sprinklers 20 of the irrigation system 12. The receiver 17 operates to receive the motionless signal 26S, to process it, and to emit an alert 17A to advise an operator, technician, or monitor that one or more of the sprinklers 20 is not functioning as desired. The alert 17A may be any audiovisual indicia, and may itself be a communication signal. Once the operator receives the alert 17A, they may proceed to inspect the one or more sprinklers 20 which are not functioning as desired, based on the location and other sprinkler identifier information contained in the motionless signal 26S. The controller 28 of the sprinkler 20 thus functions as a communication system which allows the sprinkler 20 to signal an operator that it is not functioning as desired. In the configuration of the irrigation system 12 of FIG. 1, the controller 28 communicates with the receiver 17 over relatively short distances (i.e. the dimensions of the field 10). In other possible embodiments, each of the controllers 28 of the sprinklers 20 may communicate individually with a local area network (LAN) which emits the alert 17A, or the controllers 28 may communicate individually with any another type of telecommunications network, such as the internet or a mobile-phone network, to generate the alert 17A. It will be appreciated that the operator may not be present in proximity to the field 10 when they receive the alert 17A. The alert 17A may take the form of a text, e-mail or variation in a graphical user interface on a mobile device being used by the operator.

Communication between the controller 28 of each self-diagnosing sprinkler 20 and the receiver 17 and/or the wider area network may be two-way, in that the controller 28 can both emit information and receive information. For example, the transmitter 28T of the controller 28 may receive commands from the receiver 17 and/or the wider area network to modify the flow of the fluid F through the body 22 of the sprinkler 20, which may cause the controller 28 to adjust a valve of the body 22 to increase or decrease the flow of the fluid F through the body 22. This control of fluid flow from the sprinkler 20 may allow for controlling the area of the field 10 being irrigated by each sprinkler 20 individually, and by all of the sprinklers 20 collectively. In another example of two-way communication, the transmitter 28T of the controller 28 receives commands from the receiver 17 and/or the wider area network for the controller 28 to transmit the operational history, status, or any other performance or diagnostic data of the sprinkler 20 collected by the controller 28, which may be stored in a memory of the controller 28 and which may be transmitted or retrieved for further analysis. In another example of two-way communication, the transmitter 28T of the controller 28 receives commands from the receiver 17 and/or the wider area network for the controller 28 to disable the sprinkler 20, such as by displacing a valve to shut off or substantially decrease the flow of the fluid F through the body 22 and to the sprinkler head 24.

Another possible configuration of communication of the motionless signal 26S is now described in greater detail. Referring to FIGS. 2C and 2D, the sprinkler 20 has a sprinkler receiver 28R. The sprinkler receiver 28R is in communication with the controller 28 of another self-diagnosing sprinkler 20, and functions to receive the motionless signal 26S from the other controller 28. Once received, the controller 28 of the sprinkler 20 with sprinkler receiver 28R communicates the same motionless signal 26S onwards to another sprinkler 20 that also has its own sprinkler receiver 28R. This may continue until the motionless signal 26S is ultimately received at the receiver 17 and/or the wider area network, and processed into the alert 17A. In this configuration of communicating the motionless signal 26S, one or more of the sprinklers 20 acts like a relay to receive, via their sprinkler receivers 28R, the motionless signal 26S and to then pass it along to another sprinkler 20 having its own sprinkler receiver 28R, until the motionless signal 26S reaches its final destination. The sprinklers 20 may thus communicate with each other. The motionless signal 26S may be relayed in this fashion via sprinklers 20 which are progressively closer to the receiver 17 and/or the wider area network. Each of the sprinklers 20 of the irrigation system 12 which are equipped with the sprinkler receiver 28R thus act as their own router of information (e.g. the motionless signal 26S). In an embodiment, the sprinkler receiver 28R is a component of the controller 28, and may be a component of the transmitter 28T. In an embodiment, the transmitter 28T is a transceiver, and thus functions to both transmit information from, and receive information to, the controller 28.

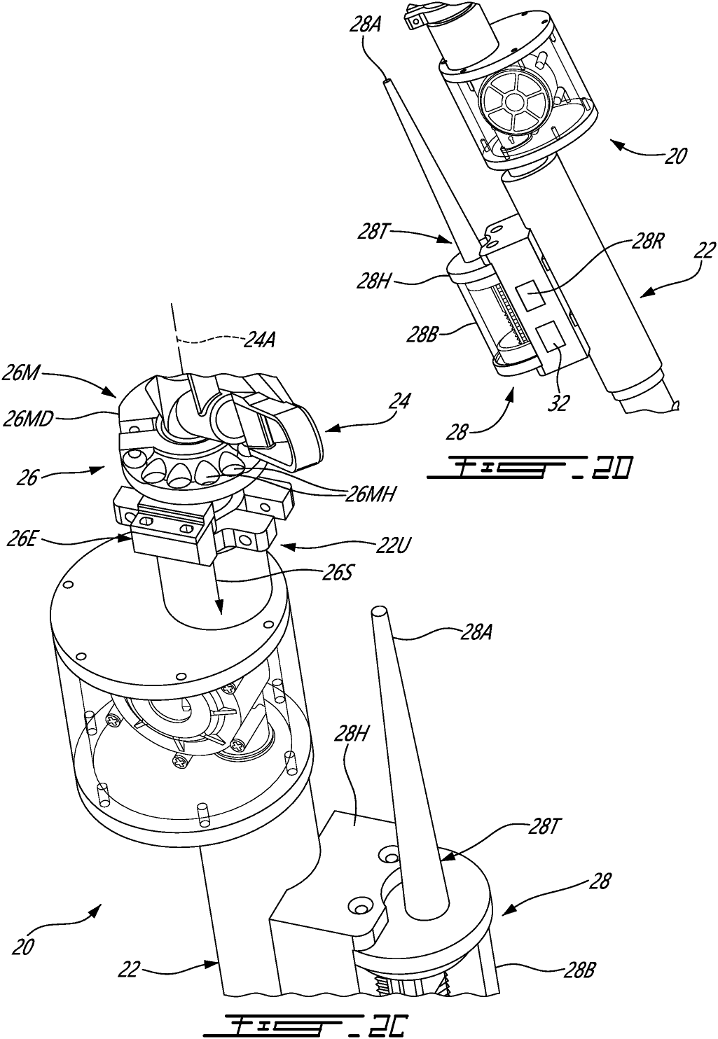

In some embodiments, the controller 28 is implemented in one or more computing devices 500, as illustrated in FIG. 3. For simplicity only one computing device 500 is shown but the controller 28 may include more computing devices 500 operable to exchange data. The computing devices 500 may be the same or different types of devices.

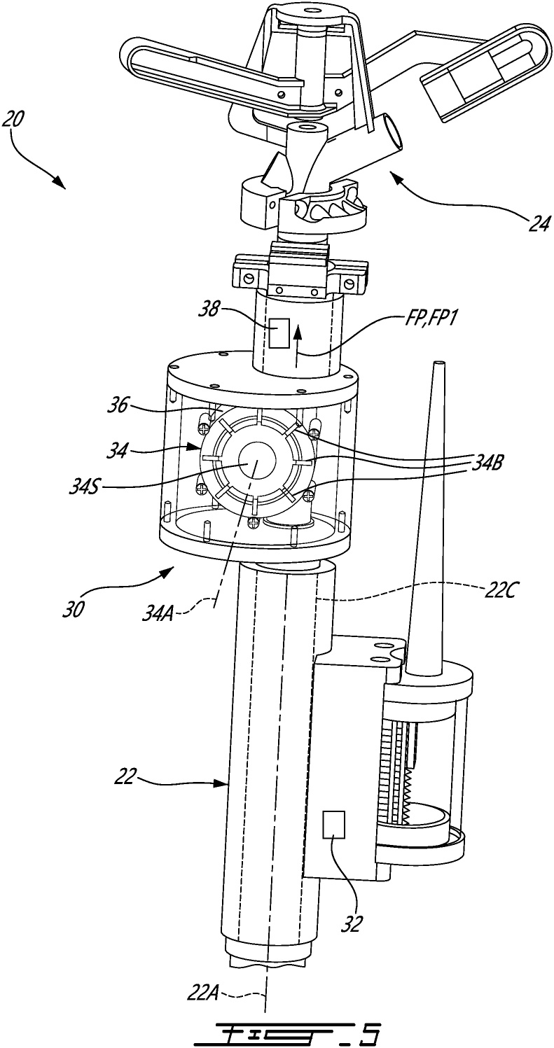

The computing device 500 comprises a processing unit 502 and a memory 504 which has stored therein computer-executable instructions 506. The processing unit 502 may comprise any suitable devices configured to implement a method such that instructions 506, when executed by the computing device 500 or other programmable apparatus, may cause the functions/acts/steps performed as part of methods 600,700,800 as described in FIGS. 6 to 8 to be executed. The processing unit 502 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 504 may comprise any suitable known or other machine-readable storage medium. The memory 504 may comprise non-transitory computer readable storage medium, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to device, for example random-access memory (RAM), read-only memory (ROM), compact disc read-only memory (CDROM), electro-optical memory, magnetooptical memory, erasable programmable read-only memory (EPROM), and electrically-erasable programmable read-only memory (EEPROM), Ferroelectric RAM (FRAM) or the like. Memory 504 may comprise any storage means (e.g., devices) suitable for retrievably storing machine-readable instructions 506 executable by processing unit 502.

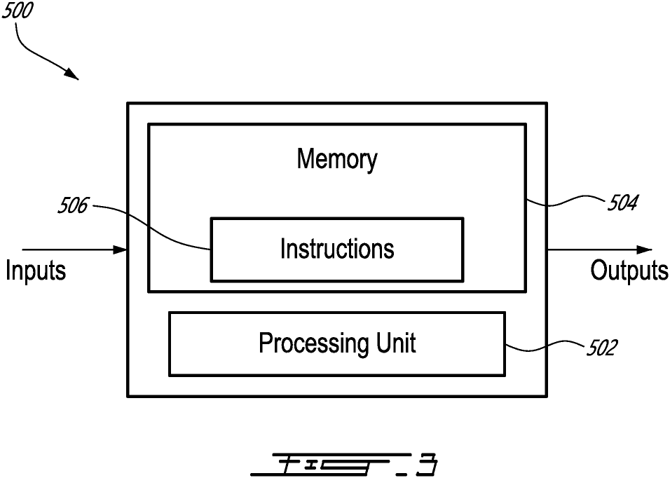

Referring to FIG. 4, there is illustrated an example embodiment of a self-diagnosing sprinkler 20. Components of the sprinkler 20 are powered by the power source 32, which may be a power supply, a battery, or any other device capable of providing electrical energy, as described in greater detail below. The motion sensor 26 monitors rotation of the sprinkler head 24. When the motion sensor 26 detects that the sprinkler head 24 is not moving as desired, the motion sensor 26 emits the motionless signal 26S to the processing unit 502 of the controller 28. The processing unit 502 executes the computer-executable instructions 506 stored in the memory 504 to process the motionless signal 26S, such as to provide the motionless signal 26S with information unique to the sprinkler 20 (i.e. a unique identifier, its position within the field 10, etc.). The transmitter 28T then outputs the motionless signal 26S wirelessly, so that it can be received by the receiver 17 and/or the wider area communication network, and the alert 17A can be generated. The sprinkler 20, and more particularly its controller 28, may also have the sprinkler receiver 28R to receive the motionless signal 26S from another self-diagnosing sprinkler 20, and to relay or transmit the received motionless signal 26S via the transmitter 28T.

The self-diagnosing sprinkler 20 disclosed herein may thus be considered an “intelligent” sprinkler 20 because of its ability to detect when it is malfunctioning (e.g. due to ice accumulation or a mechanical failure), and to signal its state of malfunction to an operator who may then inspect the sprinkler 20, and correct the situation or repair/replace the sprinkler 20. The self-diagnosing sprinkler 20 disclosed herein, when combined with similar self-diagnosing sprinklers 20 in the irrigation system 12, allows for ensuring uniform and continuous irrigation of the field 10. The self-diagnosing sprinkler 20 disclosed herein allows for identifying and signalling malfunctions in the sprinkler 20 in real-time, allowing for prompt intervention by an operator. For example, where the self-diagnosing sprinklers 20 of the irrigation system 12 are used to water or saturate the field 10 in anticipation of a frost event and thereby protect the crops 11, the ability to detect in real-time when one or more of the sprinklers 20 is malfunctioning due to ice accumulation on the sprinkler head 24 and to then have an operator promptly fix the sprinkler 20 may help to ensure that all portions of the field 10 are adequately saturated with water, and thus prevent frost damage to the crops 11.

The self-diagnosing functionality of the sprinkler 20 may be provided with a self-diagnostic kit. The self-diagnostic kit may be used to adapt or retrofit a sprinkler which does not have the self-diagnosing features disclosed herein, in order to modify that sprinkler into a self-diagnosing sprinkler 20. The self-diagnostic kit may also be installed on a new sprinkler while the new sprinkler is being manufactured, in order to provide the new sprinkler with the self-diagnosing features and functionality disclosed herein. Referring to FIGS. 2C and 2D, the self-diagnostic kit includes at least the power source 32, the motion sensor 26 and the controller 28 disclosed herein.

In one possible configuration, and in addition to being self-diagnosing, the sprinkler 20 is also self-powered. In this configuration, the sprinkler 20 contains its own power supply and may also generate its own electricity used to power the controller 28, the motion sensor 26 and/or other components of the sprinkler 20 which require electrical power.

One possible embodiment of the self-diagnosing, self-powered sprinkler 20 is now described with reference to FIG. 5. The description above of the sprinkler 20 and its components shown in FIGS. 2A-2D applies mutatis mutandis to the sprinkler 20 shown in FIG. 5. The sprinkler 20 includes a sprinkler power assembly 30. The sprinkler power assembly 30 is a system or collection of components which collectively operate to store electrical power, provide it to components of the sprinkler 20, and possibly also generate the electrical power. The sprinkler power assembly 30 includes the power source 32 of the sprinkler 20, which stores the electrical power and provides it to the components of the sprinkler 20. The power source 32 may be a battery (e.g. a coin-cell battery) that is rechargeable, or the power source 32 may be a single-use battery.

The sprinkler power assembly 30 may have one or more features which generate the electrical power needed for the components of the self-diagnosing sprinkler 20. For example, and referring to FIGS. 4 and 5, the sprinkler power assembly 30 has a rotor 34 which is rotatable about a rotor axis 34A. The rotor 34 has a rotor shaft 34S and multiple rotor blades 34B which rotate about the rotor axis 34A. The rotor 34 thus forms a fluid turbine whose rotation about the rotor axis 34A can be used to generate electricity. Specifically, the rotor blades 34B are in fluid communication with the inner cavity 22C of the body 22 of the sprinkler 20. The rotor 34 is positioned downstream of the inlet 22l of the body 22, and upstream of the sprinkler head 24. The rotor 34 is positioned axially between the inlet 22l and the sprinkler head 24 relative to the center axis 22A of the body 22. The rotor 34 is positioned vertically between the inlet 22l and the sprinkler head 24 when the sprinkler 20 is staked to the ground. The rotor blades 34B are positioned along the fluid flow path FP extending from the inlet 22l of the body 22. Referring to FIGS. 4 and 5, the rotor blades 34B are positioned along the first portion FP1 of the fluid flow path FP that extends upwardly from the inlet 22l to the sprinkler head 24, such that the fluid F flows past and through the rotor blades 34B on its way to the sprinkler head 24. The rotor blades 34B are thus configured to receive the fluid F from the inlet 22l. The flow of the fluid F along the fluid flow path FP imparts a rotational drive to the rotor blades 34B, causing them and the rotor shaft 34S to rotate about the rotor axis 34. The sprinkler power assembly 30 also has an electrical generator 36 that is mechanically coupled to the rotor shaft 34S. The rotation of the rotor shaft 34S by the flow of the fluid F along the fluid flow path FP causes the electrical generator 36 to generate electricity. The electricity generated by the electrical generator 36 may be stored in the power source 32, or may be directly used by the components of the sprinkler 20. The electrical generator 36 may have any suitable structure to achieve its functionality, such as a generator rotor that is rotatable relative to a stator encased in a suitable enclosure. The rotor 34 and the electrical generator 36 therefore take advantage of the dynamic energy of the fluid F that is already flowing through the sprinkler 20 to provide additional or all the electrical power needed to run the components of the self-diagnosing sprinkler 20. The electrical power supplied by the electrical generator 36 may be sufficient to power some or all of the components of the self-diagnosing sprinkler 20.

The sprinkler power assembly 30 may have one or more features, in addition to, or as a substitute for, the rotor 34 and the electrical generator 36, which generate the electrical power needed for the components of the self-diagnosing sprinkler 20. For example, and referring to FIGS. 4 and 5, sprinkler power assembly 30 includes a solar panel 38. The solar panel 38 is mounted to the body 22 to be exposed to sunlight in order to generate electricity. The electricity generated by the solar panel 38 may be stored in the power source 32, or may be directly used by the components of the sprinkler 20. In another possible configuration of the self-diagnosing sprinkler 20, the sprinkler power assembly 30 only has a battery power source 32 and is free of devices that may generate electricity, such that the components of the sprinkler 20 are powered only by the battery power source 32. The sprinkler 20 may have or use other power sources, such as a wind turbine or a condenser.

The sprinkler power assembly 30 therefore allows the sprinkler 20 to be self-powered and self-sustained, so that the sprinkler 20 may perform the self-diagnosing functionality disclosed in the present disclosure. By providing the sprinkler 20 with its own source of electrical power, the sprinkler power assembly 30 helps to avoid having to run wiring or cabling to multiple sprinklers 20 in the field 10, which would be impractical or cost-prohibitive for an irrigation system 12 such as the one disclosed herein which may include a large number of self-diagnosing sprinklers 20 spread out over large distances on the field 10.

The sprinkler power assembly 30 may include any other components needed to achieve the functionality ascribed to the sprinkler power assembly 30 herein. For example, the sprinkler power assembly 30 may have wiring, capacitors, etc. The electrical power provided by the sprinkler power assembly 30 may be used for additional purposes, in addition to powering the components of the self-diagnosing sprinkler 20.

There is disclosed herein methods related to the sprinkler 20 of the present disclosure.

Referring to FIG. 6, an example method 600 of detecting if or when the sprinkler 20 is inoperative is described. Although described with respect to one of the sprinklers 20 of the irrigation system 12, the method 600 may be used to monitor more than one of the sprinklers 20, such as all of the sprinklers 20, of the irrigation system 12. At step 602, the method 600 includes monitoring the rotation of the sprinkler head 24 about the sprinkler head axis 24A with the motion sensor 26. At step 604, the method includes emitting the motionless signal 26S when the motion sensor 26 detects that the sprinkler head 24 has stopped rotating, or is not rotating as desired. Step 604 may include emitting the motionless signal 26S after a threshold period of time during which the sprinkler head 24 is motionless or not rotating as desired, so as to avoid or reduce the number of false positive emissions of the motionless signal 26S. If the sprinkler head 24 is still rotating as desired, then the method 600 includes continuing monitoring rotation of the sprinkler head 24 with the motion sensor 26. The method 600 may include powering the motion sensor 26 with a flow of the fluid F flowing through the sprinkler 20, such as by using the rotor 34 and the electrical generator 36. Although the motion sensor 26 is described herein as being mounted to the body 22 of the sprinkler 20, in an alternate embodiment the motion sensor 26 is positioned away from the sprinkler 20, such as in the field 10 or on a base station, and oriented toward the sprinkler 20 to monitor the rotation of the sprinkler head 24.

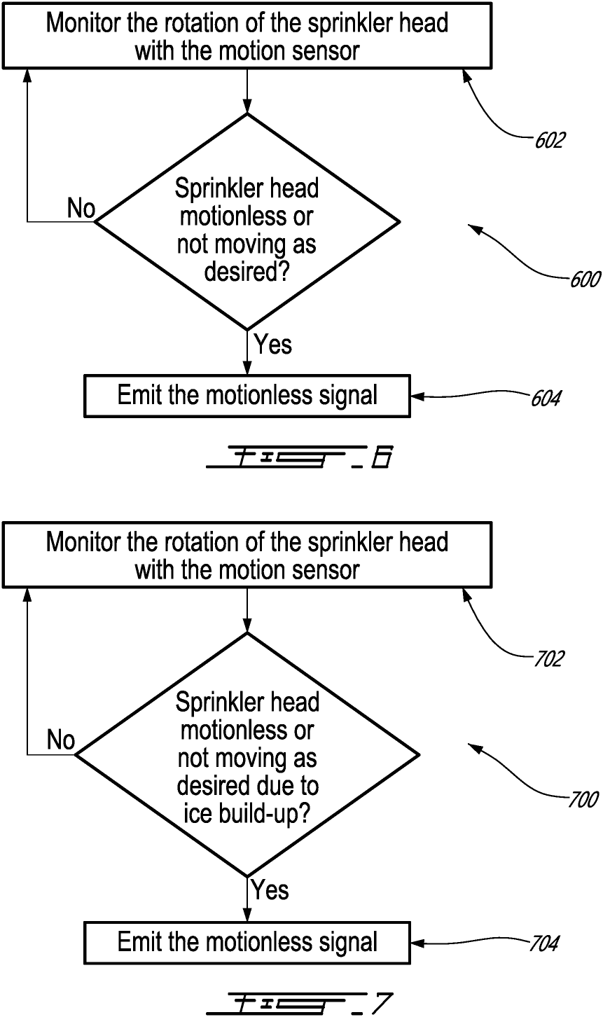

Referring to FIG. 7, another example method 700 of detecting if or when the sprinkler 20 is inoperative is described. Although described with respect to one of the sprinklers 20 of the irrigation system 12, the method 700 may be used to monitor more than one of the sprinklers 20, such as all of the sprinklers 20, of the irrigation system 12. At step 702, the method 700 includes monitoring the rotation of the sprinkler head 24 about the sprinkler head axis 24A with the motion sensor 26. At step 704, the method includes emitting the motionless signal 26S with the motion sensor 26 when ice obstructs or blocks the sprinkler head 24 and causes the sprinkler head 24 to stop rotating, or is not rotating as desired. Step 704 may include emitting the motionless signal 26S after a threshold period of time during which the sprinkler head 24 is motionless or not rotating as desired, so as to avoid or reduce the number of false positive emissions of the motionless signal 26S. If the sprinkler head 24 is still rotating as desired, then the method 700 includes continuing monitoring rotation of the sprinkler head 24 with the motion sensor 26. The method 700 may include powering the motion sensor 26 with a flow of the fluid F flowing through the sprinkler 20, such as by using the rotor 34 and the electrical generator 36. Although the motion sensor 26 is described herein as being mounted to the body 22 of the sprinkler 20, in an alternate embodiment the motion sensor 26 is positioned away from the sprinkler 20, such as in the field 10 or on a base station, and oriented toward the sprinkler 20 to monitor the rotation of the sprinkler head 24.

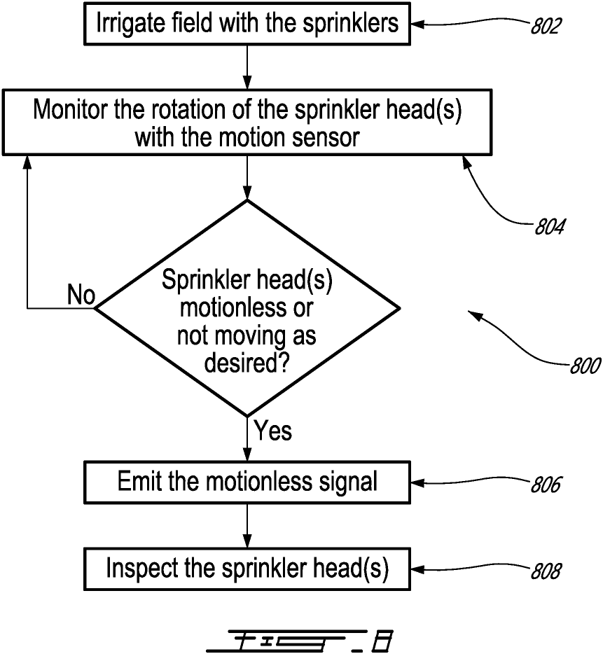

Referring to FIG. 8, an example method 800 of protecting the agriculture field 10 from frost is described. The method 800 may use the self-diagnosing sprinkler 20 disclosed herein to prevent the field 10 and/or the crops 11 from freezing or frosting during a frost event. At step 802, the method 800 includes irrigating the agriculture field 10 with the fluid F conveyed through the sprinklers 20 during or in advance of frost conditions. At step 804, the method 800 includes monitoring rotation of the sprinkler head 24 of one or more of the sprinklers 20 with the motion sensor 26. At step 806, the method 800 includes emitting the motionless signal 26S when the motion sensor 26 detects that the sprinkler head 24 of one or more of the sprinklers 20 has stopped rotating, or is not rotating as desired. Step 806 may include emitting the motionless signal 26S after a threshold period of time during which the sprinkler head(s) 24 is motionless or not rotating as desired, so as to avoid or reduce the number of false positive emissions of the motionless signal 26S. If the sprinkler head(s) 24 is still rotating as desired, then the method 800 includes continuing monitoring rotation of the sprinkler head(s) 24 with the motion sensor 26. At step 808, the method 800 includes inspecting the sprinkler head(s) 24 after the motionless signal 26S has been received, such as by the receiver 17. The sprinkler head(s) 24 is inspected to see if it has malfunctioned due to ice accumulation on the sprinkler head(s) 24 or on its components. The method 800 may include powering the motion sensor 26 with a flow of the fluid F flowing through the sprinkler 20, such as by using the rotor 34 and the electrical generator 36. Although the motion sensor 26 is described herein as being mounted to the body 22 of the sprinkler 20, in an alternate embodiment the motion sensor 26 is positioned away from the sprinkler 20, such as in the field 10 or on a base station, and oriented toward the sprinkler 20 to monitor the rotation of the sprinkler head(s) 24.

The methods 600,700,800 described herein may be implemented in a high level procedural or object oriented programming or scripting language, or a combination thereof, to communicate with or assist in the operation of a computer system, for example the computing device 500. Alternatively, the methods 600,700,800 may be implemented in assembly or machine language. The language may be a compiled or interpreted language. Program code for implementing the methods 600,700,800 may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods 600,700,800 may also be considered to be implemented by way of a non-transitory computer-readable storage medium having a computer program stored thereon. The computer program may comprise computer-readable instructions which cause a computer, or more specifically the processing unit 502 of the computing device 500, to operate in a specific and predefined manner to perform the functions described herein, for example those described in the methods 600,700,800.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An agricultural irrigation system comprising:
piping for conveying a fluid to an agriculture field; and
sprinklers, each one of the sprinklers having:
a body having an inlet and an outlet, the body having an internal cavity in fluid communication with the inlet and with the outlet, fluid configured to flow through the internal cavity along a flow path extending from the inlet to the outlet;
a sprinkler head in fluid communication with the internal cavity of the body and rotatable about a sprinkler head axis; and
a sprinkler power assembly comprising:
a rotor with a rotor shaft and rotor blades rotatable about a rotor axis, the rotor blades in fluid communication with the inner cavity and positioned along the flow path, the rotor blades and the rotor shaft configured to be rotated by the fluid flowing along the flow path; and
an electrical generator coupled to the rotor shaft.

2. The agricultural irrigation system of claim 1, wherein each sprinkler further comprises a motion sensor positioned on the body and oriented toward the sprinkler head, the motion sensor configured to emit a signal indicative of the sprinkler head having ceased to rotate about the sprinkler head axis.

3. The agricultural irrigation system of claim 2, wherein each sprinkler further comprises a controller positioned on the body and powered by the electrical generator, the controller in communication with the motion sensor to transmit the signal.

4. The agricultural irrigation system of claim 3, further comprising a wireless communication network in communication with the controller of each sprinkler, to receive from the controller the motionless signal.

5. The agricultural irrigation system of claim 4, wherein the wireless communication network is configured to emit an alert upon receiving the motionless signal.

6. The agricultural irrigation system of claim 2, wherein each motion sensor includes a magnet rotatable about the sprinkler head axis.

7. The agricultural irrigation system of claim 3 wherein each controller is configured to collect data of the corresponding sprinkler.

8. The agricultural irrigation system of claim 1, wherein each sprinkler power assembly comprises at least one of a condenser, a solar panel, and a wind turbine.

9. A sprinkler, comprising:
a body having an inlet and an outlet, the body having an internal cavity in fluid communication with the inlet and with the outlet, fluid configured to flow through the internal cavity along a flow path extending from the inlet to the outlet;
a sprinkler head in fluid communication with the internal cavity of the body and rotatable about a sprinkler head axis; and
a communication system comprising:
a power source positioned on the body;
a motion sensor positioned on the body, the motion sensor oriented toward the sprinkler head and configured to emit a motionless signal upon the sprinkler head ceasing to rotate about the sprinkler head axis; and
a controller positioned on the body and powered by the power source, the controller in communication with the motion sensor to transmit the motionless signal.

10. The sprinkler of claim 9, wherein the power source comprises:
a rotor with a rotor shaft and rotor blades rotatable about a rotor axis, the rotor blades in fluid communication with the inner cavity and positioned along the flow path, the rotor blades and the rotor shaft configured to be rotated by the fluid flowing along the flow path; and
an electrical generator coupled to the rotor shaft.

11. The sprinkler of claim 9, wherein the power source comprises a solar panel.

12. The sprinkler of claim 9, wherein the sprinkler is a first sprinkler, further comprising a other sprinklers, forming, with the first sprinkler, a plurality of sprinklers of an agricultural irrigation system, the agricultural irrigation system further having piping for conveying a fluid to an agriculture field, the piping connected to the inlet of each one of the plurality of sprinklers.

13. The sprinkler of claim 12 wherein the agricultural irrigation system further comprises a receiver in proximity to the field and in communication with the controller of each sprinkler of the at least some of the sprinklers, to receive from the controller the motionless signal.

14. The sprinkler of claim 13, wherein the receiver is configured to emit an alert upon receiving the motionless signal.

15. The sprinkler of claim 9 wherein the signal further includes information on at least a location of each sprinkler of the at least some of the sprinklers relative to the agriculture field.

16. The sprinkler of claim 9, wherein the sprinkler further has a sprinkler receiver in communication with the controller to receive the signal.

17. The sprinkler of claim 9, wherein the power source comprises:
a rotor with a rotor shaft and rotor blades rotatable about a rotor axis, the rotor blades in fluid communication with the inner cavity and positioned along the flow path, the rotor blades and the rotor shaft configured to be rotated by the fluid flowing along the flow path; and
an electrical generator coupled to the rotor shaft.

18. The sprinkler of claim 9 wherein the power source comprises a solar panel.

19. A self-diagnostic kit for a sprinkler, the self-diagnostic kit comprising:
a power source mountable to the sprinkler;
a motion sensor mountable to the sprinkler to be oriented toward a rotatable sprinkler head, the motion sensor configured to emit a motionless signal upon the rotatable sprinkler head ceasing to rotate; and
a controller configured to be powered by the power source and to transmit the motionless signal.

20. The self-diagnostic kit of claim 19, wherein the power source comprises:
a rotor with a rotor shaft and rotor blades rotatable about a rotor axis, the rotor blades and the rotor shaft mountable to the sprinkler and configured to be rotated by fluid flowing through the sprinkler; and
an electrical generator configured to be coupled to the rotor shaft.
